(19) United States
(12) Patent Application Publication
(10) Pub. No.: US 2021/0276395 A1
(43) Pub. Date: Sep. 9, 2021

(54) Combined Stone Guard And Air Conditioning Condenser

(71) Applicant: DENSO International America, Inc., Southfield, MI (US)

(72) Inventor: Sarah BURTCH, Novi, MI (US)

(21) Appl. No.: 16/811,792

(22) Filed: Mar. 6, 2020

(51) Int. Cl. B60H 1/00; B60R 19/52; B60R 19/18

(52) U.S. Cl. CPC B60H 1/00328; B60R 2019/525; B60R 19/18; B60R 19/52

(57) ABSTRACT

A stone guard for a vehicle including a plurality of tubes arranged as a mesh configured to restrict passage of stones through the mesh. A plurality of channels are defined within the plurality of tubes for circulating refrigerant through the plurality of tubes. A refrigerant inlet is defined by at least one of the plurality of tubes through which refrigerant enters the stone guard. A refrigerant outlet is defined by at least one of the plurality of tubes through which refrigerant exits the stone guard. As the refrigerant circulates through the plurality of channels, heat is released from the refrigerant.

### FIELD

The present disclosure relates to a combined stone guard and air conditioning condenser for a vehicle.

### BACKGROUND

This section provides background information related to the present disclosure, which is not necessarily prior art.

Vehicles often include a stone guard positioned in the front of the vehicle to protect a radiator and/or condenser from being damaged by stones or other debris. While current stone guards are suitable for their intended use, they are subject to improvement. For example, current stone guards undesirably add weight to the vehicle and require installation of an additional separate component, thereby increasing assembly time and cost. The present disclosure includes an improved stone guard.

### SUMMARY

This section provides a general summary of the disclosure, and is not a comprehensive disclosure of its full scope or all of its features.

The present disclosure includes a stone guard for a vehicle having a plurality of tubes arranged as a mesh configured to restrict passage of stones through the mesh. A plurality of channels are defined within the plurality of tubes for circulating refrigerant through the plurality of tubes. A refrigerant inlet is defined by at least one of the plurality of tubes through which refrigerant enters the stone guard. A refrigerant outlet is defined by at least one of the plurality of tubes through which refrigerant exits the stone guard. As the refrigerant circulates through the plurality of channels, heat is released from the refrigerant.

The present disclosure also includes a stone guard for a vehicle including a plurality of tubes arranged as a mesh configured to restrict passage of stones through the mesh. A plurality of channels is defined within the plurality of tubes for circulating refrigerant of a vehicle heating, ventilation, and air conditioning (HVAC) system through the plurality of tubes. A plurality of heat dissipaters are within the plurality of channels. The plurality of heat dissipaters are configured to maximize heat dissipation and facilitate refrigerant flow through the plurality of channels. A refrigerant inlet is defined by at least one of the plurality of tubes through which refrigerant enters the stone guard. A refrigerant outlet is defined by at least one of the plurality of tubes through which refrigerant exits the stone guard. The stone guard is configured for connection to a compressor and an evaporator of the HVAC system by way of the refrigerant inlet and the refrigerant outlet for circulation of the refrigerant between the compressor, the stone guard, and the evaporator. As the refrigerant circulates through the plurality of channels, heat is released from the refrigerant. The plurality of tubes differ in at least one of the following: modulus of elasticity, tensile strength, and yield strength.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of an exemplary vehicle including stone guards in accordance with the present disclosure each configured as a front grille of a vehicle;

FIG. 2 is a top view of a front portion of the vehicle of FIG. 1 showing various components of the vehicle in phantom, such as one of the stone guards of FIG. 1, an engine, and various components for cooling the engine and the passenger cabin of the vehicle;

FIG. 3 illustrates an exemplary stone guard in accordance with the present disclosure configured as a front grille of the vehicle of FIG. 1;

FIG. 4A is a cross-sectional view taken along line 4A-4A of FIG. 3;

FIG. 4B is a perspective view of a tube of the stone guard through which the cross-sectional view of FIG. 4A is taken;

FIG. 5 is a cross-sectional view taken along line 5-5 of FIG. 3;

FIG. 6A is a cross-sectional view taken along line 6A-6A of FIG. 3;

FIG. 6B is a perspective view of a tube of the stone guard of FIG. 3 through which the cross-section of FIG. 6A is taken; and

FIG. 7 is another exemplary stone guard in accordance with the present disclosure.

Corresponding reference numerals indicate corresponding parts throughout the several views of the drawings.

### DETAILED DESCRIPTION

Example embodiments will now be described more fully with reference to the accompanying drawings.

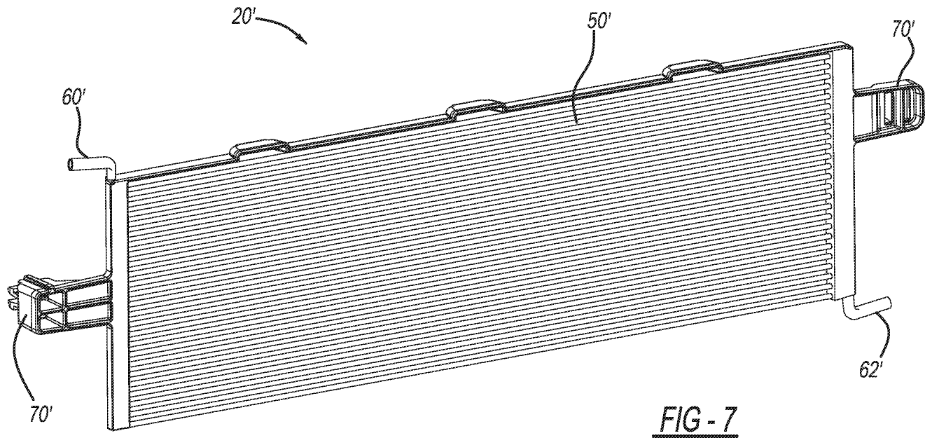

FIG. 1 illustrates an exemplary vehicle 10 including various stone guards in accordance with the present disclosure configured as front grilles of the vehicle 10. For example, FIG. 1 illustrates a center stone guard 20, a lower stone guard 22, a first side stone guard 24, and a second side stone guard 26. Although the vehicle 10 is illustrated as a passenger vehicle, the stone guards of the present disclosure, such as the stone guards 20, 22, 24, and 26 (as well as the stone guard 20′ of FIG. 7, which is described further herein) can be used with any other suitable vehicle, as well as with any suitable non-vehicular application. Other suitable vehicles include, but are not limited to, the following: mass transit vehicles; recreational vehicles; utility vehicles; construction vehicles/equipment; military vehicles/equipment; aircraft; watercraft, etc.

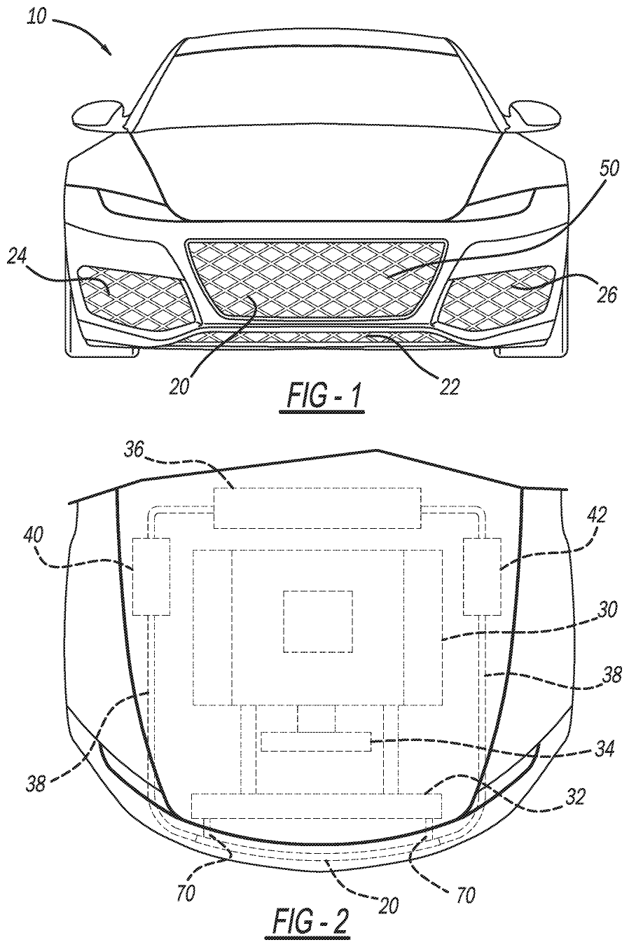

With continued reference to FIG. 1 and additional reference to FIG. 2, the vehicle 10 includes any suitable engine 30, as well as a radiator 32 and a fan 34 for cooling the engine 30. The vehicle 10 also includes an evaporator 36 for cooling a passenger cabin of the vehicle 10, a compressor 40, and a thermal expansion valve (TXV) 42. Refrigerant is circulated from the evaporator 36 to the compressor 40, the stone guard 20, the TXV 42, and back to the evaporator 36 by way of conduits 38, which may be any suitable conduits for circulating refrigerant. The compressor 40 compresses the refrigerant gas flowing from the evaporator 36, thereby increasing the temperature of the refrigerant and changing it to a high pressure gas.

Although FIG. 2 illustrates the evaporator 36 in fluid communication with the center stone guard 20, the evaporator 36 may also be in fluid communication with any of the other stone guards 22, 24, 26 and/or 26′. As explained herein, refrigerant circulates through the stone guard 20. As the refrigerant circulates through the stone guard 20, heat is released from the refrigerant into the surrounding atmosphere, and thus the stone guard 20 advantageously functions as a condenser when refrigerant is circulated therethrough. The position of the stone guard 20 advantageously protects the radiator 32 from being contacted by stones or any other road debris that may damage the radiator 32.

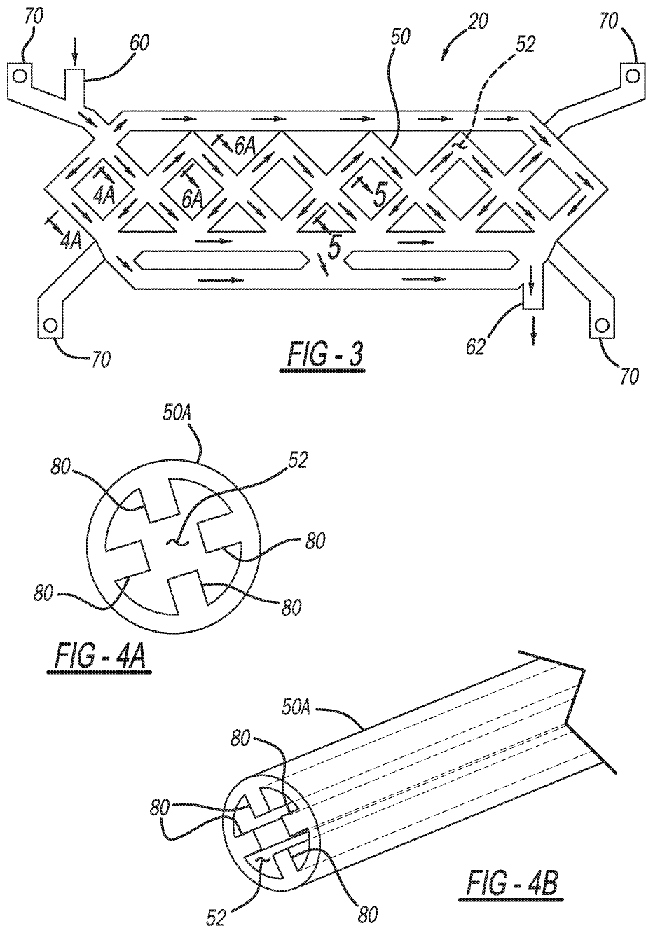

With continued reference to FIGS. 1 and 2, and additional reference to FIG. 3, the stone guard 20 will now be described in additional detail. The stone guard 20 includes a plurality of tubes 50, which are arranged as a mesh configured to restrict the passage of stones and other road debris through the stone guard 20, thereby protecting the radiator 32. The tubes 50 define channels 52 through which refrigerant flows through the stone guard 20. The tubes 50 define one or more refrigerant inlets 60, and one or more refrigerant outlets 62. The refrigerant inlet 60 may be placed in fluid communication with a refrigerant outlet of the compressor 40 by way of the conduit 38 to receive refrigerant flow therefrom. The refrigerant outlet 62 may be placed in fluid communication with a refrigerant inlet of the evaporator 36 by way of the conduit 38 to allow refrigerant to flow from the stone guard 20 to the evaporator 36. The stone guard 20 may include one or more mounts 70 for mounting the stone guard 20 at any suitable position. For example and as illustrated in FIG. 2, the mounts 70 may be used to mount the stone guard 20 directly to the radiator 32 and/or to the frame of the vehicle 10.

The stone guard 20 may be formed in any suitable manner, such as by way of any suitable additive manufacturing process, such as three-dimensional printing. The stone guard 20 may be formed of a metallic material, or any other suitable material. The stone guard 20 can be formed such that different tubes 50 have different properties and configurations. For example, different tubes 50 may differ with respect to one or more of the following: modulus of elasticity, tensile strength, and yield strength. As a result, areas of the stone guard 20 that are most susceptible to damage by stones or other debris may be made stronger than areas that are less likely to be damaged. The cross-sectional area of the channels 52 may also be different at different areas of the stone guard 20 to facilitate refrigerant flow and heat exchange between the refrigerant and the surrounding environment.

Different portions of the tubes 50 may be configured with different heat dissipaters 80, 82, 84 configured to maximize heat dissipation and facilitate refrigerant flow through the tubes 50, such as by increasing the surface area exposed to refrigerant flow, as described herein and illustrated in FIGS. 4A-6B. Configuring different tubes 50 with the different heat dissipaters described herein can advantageously improve refrigerant flow and heat exchange at select portions of the stone guard 20, such as portions that may be susceptible to reduced refrigerant flow (e.g., curves in the tubes 50).

FIGS. 4A and 4B illustrate a particular portion of the tubes 50 at reference numeral 50A. Exemplary heat dissipaters 80 are illustrated in the form of elongated fins. The heat dissipaters 80 are spaced apart about a circumference of the channel 52, and extend lengthwise along the tube 50A. Although heat dissipaters 80 in the form of elongated fins are illustrated in the tubes 50 proximate to 4A-4A of FIG. 3, any of the other portions of the tubes 50 can include heat dissipaters in the form of fins.

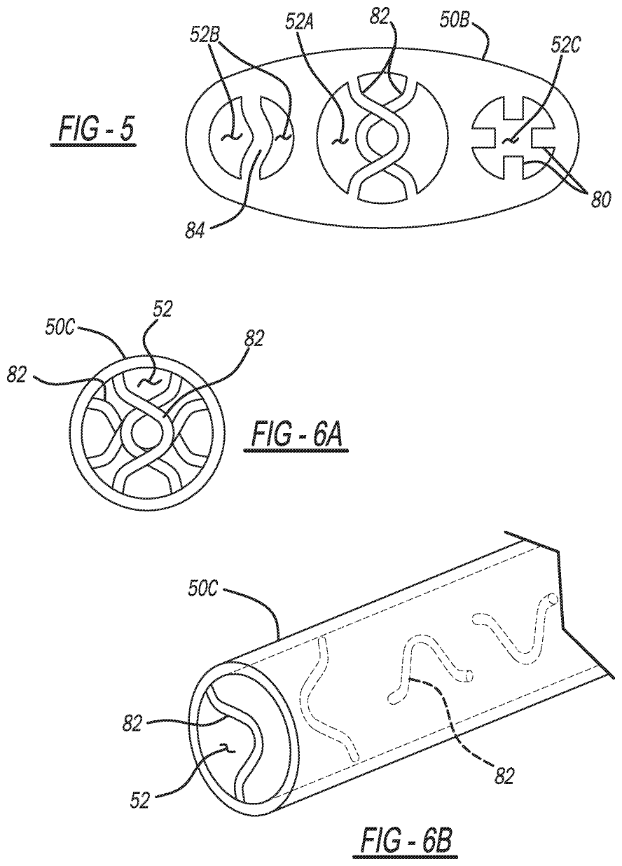

FIG. 5 is a cross-sectional view of another one of the tubes 50 at reference numeral 50B. The tube 50B defines three separate channels 52 therethrough, which extend in parallel relative to each other. Specifically, the tube 50B defines a center channel 52A, a first side channel 52B, and a second side channel 52C. Each one of the channels 52A, 52B, and 52C includes different heat dissipaters. With respect to center channel 52A, heat dissipaters 82 in the form of rods extend across the center channel 52A. The rods may extend linearly, or be curved as illustrated. The rods are spaced apart from one another along the length of the center channel 52A, similar to the arrangement of the rods illustrated in FIG. 6B and described herein. The rods are rotated relative to one another along the length of the center channel 52A, such that neighboring rods have different orientations, similar to the configuration of the rods of FIG. 6B. First side channel 52B includes a heat dissipater 84 in the form of a curved divider extending lengthwise along the first side channel 52B generally dividing the first side channel 52B into two different cavities or halves. Second side channel 52C includes heat dissipaters 80 in the form of elongated plates, such as described above in the description of FIGS. 4A and 4B. The channels 52A, 52B, 52C may be arranged at 5A-5A of FIG. 3, or at any other suitable area of the tubes 50.

FIGS. 6A and 6B illustrate another portion of the tubes 50 at reference numeral 50C. The tube 50C includes a plurality of the heat dissipaters 82 in the form of rods, which are spaced apart along the length of the tube 50C. Neighboring ones of the rods are rotated relative to one another such that neighboring rods have different orientations. The rods may be curved along their lengths as illustrated, or may extend linearly across the channel 52 perpendicular to the length of the channel 52 and the tube 50C. Although heat dissipaters 82 in the form of rods are illustrated in the tubes 50 proximate to 6A-6A of FIG. 3, any of the other portions of the tubes 50 can include heat dissipaters in the form of fins or plates.

Although FIG. 1 illustrates the stone guard 20 as a front grille of vehicle 10, the present disclosure also contemplates the stone guard being configured for arrangement behind a front grille of a vehicle. For example and as illustrated in FIG. 7, another stone guard in accordance with the present disclosure is illustrated at reference numeral 20′. The stone guard 20′ is configured to be mounted inboard of a vehicle front grille. The stone guard 20′ includes numerous, if not all, of the features of the stone guard 20. Features of the stone guard 20′ that are similar to, or the same as, the stone guard 20 are identified in FIG. 7 using the same reference numerals used to describe the stone guard 20, but with the prime (′) designation added to the reference numerals. The description of the stone guard 20 thus also applies to the stone guard 20′. The mounts 70′ may be used to mount the stone guard 20′ to the radiator 32 and/or to the frame of the vehicle 10, or at any other suitable position within the vehicle 10, or in any other suitable vehicle or non-vehicular application. The tubes 50′ define channels that are the same as, or substantially similar to, the channels 52 of the stone guard 20. The tubes 50′ thus include any suitable heat dissipaters configured to facilitate refrigerant flow therethrough and release of heat from the refrigerant into the surrounding environment, such as any one or more of the heat dissipaters 80, 82, and 84 described above. The stone guard 20′ can be placed in fluid communication with the evaporator 36 and the compressor 40 by way of an inlet 60′ and an outlet 62′ to circulate refrigerant through the guard 20′ and back to the evaporator 36 through the TXV 42.

The present disclosure thus advantageously provides for stone guards 20 and 20′, which are configured to block stones and other debris from damaging, for example, a radiator 32. Furthermore, the stone guards 20 and 20′ have the added advantage of acting as condensers for circulating refrigerant therethrough to allow heat to be released from the refrigerant. The stone guards 20 and 20′ advantageously combine the functionality of a stone guard with that of a condenser, thereby reducing the weight of a vehicle in which the stone guards 20, 20′ are installed, and advantageously reducing assembly time and costs. To facilitate refrigerant flow, the stone guards 20, 20′ include various heat dissipaters within the tubes 50, 50′, such as heat dissipaters 80, 82, and 84.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A stone guard for a vehicle comprising:
a plurality of tubes arranged as a mesh configured to restrict passage of stones through the mesh;
a plurality of channels defined within the plurality of tubes for circulating refrigerant through the plurality of tubes;
a refrigerant inlet defined by at least one of the plurality of tubes through which refrigerant enters the stone guard; and
a refrigerant outlet defined by at least one of the plurality of tubes through which refrigerant exits the stone guard;
wherein as the refrigerant circulates through the plurality of channels heat is released from the refrigerant.

2. The stone guard of claim 1, wherein the stone guard is connected to a compressor and an evaporator of a vehicle heating, ventilation, and air conditioning (HVAC) system for circulation of the refrigerant between the compressor, the stone guard, and the evaporator.

3. The stone guard of claim 1, wherein the stone guard is configured to function as a condenser as the refrigerant circulates through the plurality of channels.

4. The stone guard of claim 1, wherein the stone guard is a vehicle front grille.

5. The stone guard of claim 1, wherein the stone guard is configured to be mounted to at least one of a radiator and a vehicle frame.

6. The stone guard of claim 1, wherein the plurality of tubes are metallic tubes formed by additive manufacturing to define the plurality of channels.

7. The stone guard of claim 1, further comprising a heat dissipater within at least some of the plurality of channels, the heat dissipater configured to maximize heat dissipation and facilitate refrigerant flow through the plurality of channels.

8. The stone guard of claim 7, wherein the heat dissipater includes a plurality of elongated fins extending along lengths of the plurality of channels.

9. The stone guard of claim 7, wherein the heat dissipater includes a plurality of spaced apart rods extending perpendicular to lengths of the plurality of channels.

10. The stone guard of claim 9, wherein the plurality of spaced apart rods are curved.

11. The stone guard of claim 9, wherein the plurality of spaced apart rods are rotated relative to one another along the lengths of the plurality of channels.

12. The stone guard of claim 1, wherein the plurality of tubes differ in at least one of the following: modulus of elasticity, tensile strength, and yield strength.

13. The stone guard of claim 1, wherein at least one of the plurality of tubes defines at least two of the plurality of channels extending in parallel.

14. The stone guard of claim 13, wherein each one of the at least two of the plurality of channels extending in parallel includes a heat dissipater configured to maximize heat dissipation and facilitate refrigerant flow through the plurality of channels.

15. A stone guard for a vehicle comprising:
a plurality of tubes arranged as a mesh configured to restrict passage of stones through the mesh;
a plurality of channels defined within the plurality of tubes for circulating refrigerant of a vehicle heating, ventilation, and air conditioning (HVAC) system through the plurality of tubes;
a plurality of heat dissipaters within the plurality of channels, the plurality of heat dissipaters configured to maximize heat dissipation and facilitate refrigerant flow through the plurality of channels;
a refrigerant inlet defined by at least one of the plurality of tubes through which refrigerant enters the stone guard; and
a refrigerant outlet defined by at least one of the plurality of tubes through which refrigerant exits the stone guard;
wherein the stone guard is configured for connection to a compressor and an evaporator of the HVAC system by way of the refrigerant inlet and the refrigerant outlet for circulation of the refrigerant between the compressor, the stone guard, and the evaporator;
wherein as the refrigerant circulates through the plurality of channels heat is released from the refrigerant; and
wherein the plurality of tubes differ in at least one of the following: modulus of elasticity, tensile strength, and yield strength.

16. The stone guard of claim 15, wherein at least one of the plurality of tubes defines at least two of the plurality of channels extending in parallel and including the plurality of heat dissipaters therein.

17. The stone guard of claim 15, wherein the stone guard is configured to function as a condenser as the refrigerant circulates through the plurality of channels.

18. The stone guard of claim 15, wherein the stone guard is a vehicle front grille.

19. The stone guard of claim 15, wherein the stone guard is configured to be mounted to at least one of a radiator and a vehicle frame.

20. The stone guard of claim 15, wherein the plurality of tubes are metallic tubes formed by additive manufacturing to define the plurality of channels.
